(19) United States
(12) Patent Application Publication
(10) Pub. No.: US 2008/0165384 A1
(43) Pub. Date: Jul. 10, 2008

(54) IMAGE FORMING APPARATUS AND IMAGE FORMING METHOD

(75) Inventor: Sun-kye HWANG, Suwon-si (KR)

Correspondence Address: STANZIONE & KIM, LLP, 919 18TH STREET, N.W., SUITE 440, WASHINGTON, DC, 20006, US

(73) Assignee: Samsung Electronics Co., Ltd., Suwon-si (KR)

(21) Appl. No.: 11/966,202

(22) Filed: Dec. 28, 2007

(30) Foreign Application Priority Data
Jan. 5, 2007 (KR) 2007-1616

(51) Int. Cl. G06F 15/00

(52) U.S. Cl. 358/1.15

(57) ABSTRACT

An image forming apparatus may include an image forming unit to form image data according to a selected image forming option, a user interface to specify an option name and a corresponding image forming option, a storage section to store the corresponding image forming option and formed image data matched to the option name, and a control section to receive a request signal with a target option name from a networked image forming apparatus, the control section to determine whether stored option names match the received target option name. Embodiments of an image forming apparatus can perform an image forming operation only with the option name by matching the image forming option and/or the image data to the option name.

### CROSS-REFERENCE TO RELATED APPLICATIONS

This application claims priority under 35 U.S.C. § 119(a) from Korean Patent Application No. 2007-1616, filed Jan. 5, 2007, the contents of which are incorporated herein by reference in its entirety.

### BACKGROUND OF THE INVENTION

1. Field of the Invention

The present general inventive concept relates to an image forming apparatus and an image forming method, and more particularly to an image forming apparatus and an image forming method that can perform an image forming operation using an option name.

2. Description of the Related Art

An image forming apparatus can reproduce or print a document or data on a medium (e.g., paper), and/or an image forming apparatus can replicate or copy a document through an operation (e.g., scanning) that may include a scanner, a copier, and a multi function peripheral.

In the case in which a document is scanned or printed using an image forming apparatus, a user generally sets a scanning method or a printing method. In this case, the scanning method may include single surface scanning, double surface scanning or the like, and the printing method may include single surface printing, double surface printing, book printing, a booklet printing or the like. In the case in which a user frequently uses a specific scanning method and/or a specific printing method, the frequently used methods may be stored in the image forming apparatus itself.

On the other hand, in recent years, a network system connecting a plurality of image forming apparatus by a network to use the plurality of image forming apparatus has been used. In this environment, a user may select an arbitrary one of the plurality of image forming apparatus connected by the network. In this case, if the user selects an image forming apparatus that has not been previously used by the user, it is necessary to newly set a scanning method or a printing method, which can be bothersome and/or time-consuming for the user.

Especially, there is an occasion in which some pages of a document including a plurality of pages are scanned by a first image forming apparatus and the other pages are scanned by a second image forming apparatus. In this case, it is necessary to set the scanning method for scanning the other pages in the second image forming apparatus (as was set in the first image forming apparatus), which can be bothersome and/or time-consuming to the user.

Further, in the case in which the data scanned in several dispersed apparatus are to be printed, the scanning data stored in each image forming apparatus is individually searched for using a PC and a printing command is individually input to each dispersed image forming apparatus. Further, the document printed in each image forming apparatus is directly collected and arranged by a user in the order of pages. Accordingly, the convenience for a user is deteriorated.

### SUMMARY OF THE INVENTION

The present general inventive concept provides an image forming apparatus and an image forming method that can perform an image forming operation by matching an image forming option and image data to an option name and/or by searching for the image forming option and the image data only with the option name.

Additional aspects and utilities of the present general inventive concept will be set forth in part in the description which follows and, in part, will be obvious from the description, or may be learned by practice of the general inventive concept.

The foregoing and/or other aspects and utilities of the present general inventive concept may be achieved by providing an image forming apparatus including an image forming section to form image data according to a set image forming option, a user interface to endow an option name capable of being specified with respect to the set image forming option, a storage section matching the set image forming option and the formed image data to the option name and storing the set image forming option and the formed image data, and a control section transmitting at least one of the image forming option and the image data matched to a same option name as a target option name to another image forming apparatus, if a request signal including the target option name is received from the another image forming apparatus.

If the request signal including the target option name is a request signal on the image forming option, the control section may transmit the image forming option matched to the same option name as the target option name to the another image forming apparatus.

If the request signal including the target option name is a request signal on the image data, the control section may transmit the image data matched to the same option name as the target name to the another image forming apparatus.

The image forming apparatus may further include an interface section to perform transmission and reception of data to and from an external network In this case, if a search option name is input through the user interface section, the control section may receive at least one of the image forming option and the image data matched to a same option name as the search option name from a different image forming apparatus by transmitting a request signal including the search option name to the external network through the interface section.

If the image forming option matched to the same option name as the search option name is received, the control section may control the image forming section to scan a document according to the received image forming option and to form the image data.

If the image data matched to the same option name as the search option name is received, the control section may control the image forming section to print the received image data on a paper.

The image forming option may be one of a scan type option, a print type option, and a print order option.

The foregoing and/or other aspects and utilities of the present general inventive concept may also be achieved by providing an image forming apparatus including an interface section to perform transmission and reception of data to and from an external network, a user interface section to input a search option name, and a control section to receive at least one of an image forming option and image data which are matched to the search option name by transmitting a request signal including the search option name to the external network through the interface section.

The image forming apparatus may further include an image forming section performing an image forming operation. In this case, when the image forming option matched to the search option name is received, the control section may control the image forming section to perform an image forming operation for scanning a document according to the received image forming option.

Further, the image forming apparatus may further include an image forming section performing an image forming operation. In this case, when the image data the matched to the search option name is received, the control section may control the image forming section to perform an image forming operation for printing the received image data.

The image forming option may be at least one of a scan type option, a print type option, or a print order option.

The foregoing and/or other aspects and utilities of the present general inventive concept may also be achieved by providing an image forming method of a first image forming apparatus connected to a second image forming apparatus through an interface that includes endowing a first option name capable of being specified with respect to a set image forming option, forming image data by scanning a document according to the set image forming option, matching the set image forming option and the formed image data to the first option name and storing the set image forming option and the formed image data, and transmitting at least one of the image forming option or the image data that are matched to the first option name to the second image forming apparatus, when a request signal including a target option name matched to the first option name is received from the second image forming apparatus.

In transmitting, when the request signal including the target option name received from the second image forming apparatus is a request signal on the image forming option, the image forming option for to the first option name matched to the target option name may be transmitted to the second image forming apparatus.

In transmitting, when the request signal including the target option name received from the second image forming apparatus is a request signal on the image data, the image forming data for the first option name matched to the target option name may be transmitted to the second image forming apparatus.

The image forming method may further include inputting a search option name through a user interface, and receiving at least one of the image forming option and the image data for an option name matched to the search option name from the second image forming apparatus by transmitting a request signal including the search option name through the interface section.

In The image forming method may further include forming the image data by scanning a document according to the received image forming option when the image forming option for the option name matched to the search option name is received from the second image forming apparatus.

Further, the image forming method may further include forming the image data by printing the received image data on a paper when the image data for the option name matched to the search option name are received from the another image forming apparatus.

The image forming option may be at least one of a scan type option, a print type option, and a print order option.

The foregoing and/or other aspects and utilities of the present general inventive concept may also be achieved by providing an image forming apparatus including an image forming unit to form image data according to a selected image forming option, a user interface to specify an option name and a corresponding image forming option configured to include at least one characteristic of image forming, a storage section to store the corresponding image forming option and formed image data matched to the option name, and a control section to receive a request signal with a target option name from a networked image forming apparatus, the control section to determine whether stored option names match the received target option name.

The foregoing and/or other aspects and utilities of the present general inventive concept may also be achieved by providing an image forming apparatus including an interface section to perform transmission and reception of data to and from an external network, a user interface section to input a search option name, and a control section to receive at least one of an image forming option or image data matched to the search option name by transmitting a request signal including the search option name to the external network through the interface section.

The foregoing and/or other aspects and utilities of the present general inventive concept may also be achieved by providing an image forming method including providing an option identifier for a corresponding image forming option configured to have at least one image forming parameter, forming image data by scanning according to a selected image forming option, storing one or more of a corresponding image forming option or a corresponding image data matched to each option identifier, and transmitting at least one of the image forming option or the image data matched to a first option identifier from a first image forming apparatus to a second image forming apparatus when a request signal including a target option name corresponding to the first option identifier is received from the second image forming apparatus.

### BRIEF DESCRIPTION OF THE DRAWINGS

These and/or other aspects and utilities of the present general inventive concept will become apparent and more readily appreciated from the following description of embodiments of the present general inventive concept, taken in conjunction with the accompanying drawings of which:

FIG. 1 is a diagram illustrating an image forming system according to an exemplary embodiment of the present general inventive concept;

FIG. 2 is a block diagram illustrating an image forming apparatus according to an exemplary embodiment of the present general inventive concept;

FIG. 3 is a block diagram illustrating an image forming apparatus according to another exemplary embodiment of the present general inventive concept;

FIGS. 4A and 4B are diagrams illustrating user interfaces according to various exemplary embodiment of the present general inventive concept;

FIG. 5 is a flow chart illustrating an image forming method of an image forming apparatus according to an exemplary embodiment of the present general inventive concept; and

FIG. 6 is a flow chart illustrating an image forming method of an image forming apparatus according to another exemplary embodiment of the present general inventive concept.

### DETAILED DESCRIPTION OF THE PREFERRED EMBODIMENTS

Reference will now be made in detail to the exemplary embodiments of the present general inventive concept, examples of which are illustrated in the accompanying drawings, wherein like reference numerals refer to the like elements throughout. The exemplary embodiments are described below in order to explain the present general inventive concept by referring to the figures.

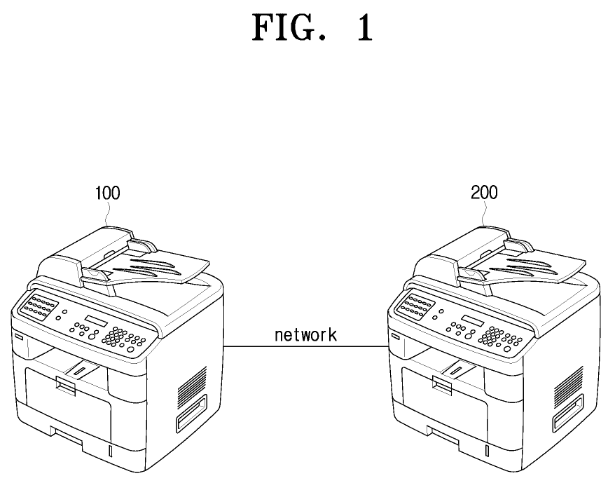

FIG. 1 is a diagram illustrating an image forming system according to an exemplary embodiment of the present general inventive concept. As illustrated in FIG. 1, the image forming system may include a first image forming apparatus 100 and a second image forming apparatus 200. The first image forming apparatus 100 and the second image forming apparatus 200 are coupled to each other through a network in order to perform transmission and reception of data.

An image forming option and an option name may be set in the first image forming apparatus 100 through a user's input before a document is scanned. Accordingly, the first image forming apparatus 100 may then scan a document according to the set image forming option and to form image data. In this case, the first image forming apparatus 100 can match the image forming option and the image data to the corresponding option name and stores the image forming option and the image data.

Thereafter, if the first image forming apparatus 100 receives a request signal including a target option name from the second image forming apparatus 200, the first image forming apparatus 100 can transmit at least one of the image forming option and the image data, which have been matched to a same option name (e.g., corresponding to or equal to) as the target option name, to the second image forming apparatus 200 through a network. For example, the target option name may refer to an option name that is a target to be provided to the second image forming apparatus 200. If the first image forming apparatus 100 receives a request signal on the image forming option from the second image forming apparatus 200 together with the target option name, the first image forming apparatus 100 can provide the image forming option matched to the same option name as the received target option name to the second image forming apparatus 200.

On the other hand, if a request signal on the image data is received together with the target option name by the first image forming apparatus 100, the image data matched to the same option name as the received target option name is provided to the second image forming apparatus 200. For example, the image data produced according to the image forming option corresponding to the target option name may be provided to the second image forming apparatus 200. In addition, the second image forming apparatus 200 can request the image data and the image forming option together (e.g., using the target option name) in order to receive them.

As variously described above, the second image forming apparatus 200 can be directly provided with the image data and the image forming option using the option name. For example, if a search option name to search for the image forming option and the image data is input by a user, the second image forming apparatus 200 may transmit a request signal including the search option name to the first image forming apparatus 100. Here, the search option name refers to an option name that is an object to be searched for. Since the search option name refers to an option name to be searched for by a user and the target option name refers to an option name to be provided to another image forming apparatus, the two option names are rather different in concept, but may refer to a substantially same option name.

Accordingly, if an image forming option or image data are transmitted from the first image forming apparatus 100, the second image forming apparatus 200 can perform an image forming operation using them. In this case, the image forming operation refers to an operation for forming image data by scanning a document, an operation for printing image data on a printing medium such as paper, or the like.

In another embodiment, if a search option name is input through a user interface, the first image forming apparatus 100 may search for the image forming option and the image data, which have been matched to the same option name as the search option name, by itself and transmit a request signal including the search option name to the second image forming apparatus 200 at the same time. Accordingly, if the image forming option and the image data, which have been matched to the same option name as the search option name, is received by the second image forming apparatus 200, the first image forming apparatus 100 may perform an image forming operation using the image forming option and the image data, which have been searched for by itself, and/or the image forming option and the image data which have been received. In this way, the image forming option and the printing data can be searched for only with the option name to allow a scanning of a document and a printing of image data according to the image forming option, by matching the option name to the image forming option and the image data.

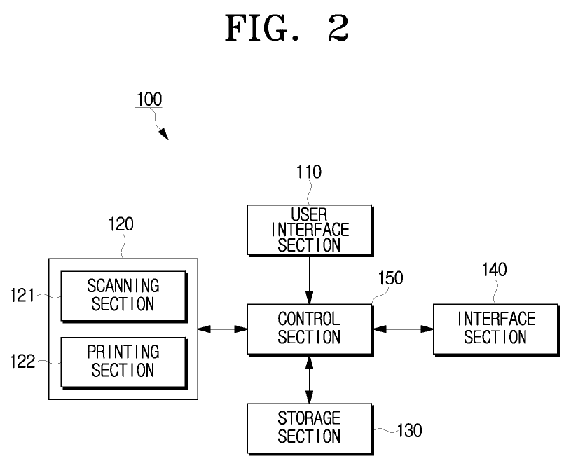

FIG. 2 is a block diagram illustrating an image forming apparatus according to an exemplary embodiment of the present general inventive concept. As illustrated in FIG. 2, the image forming apparatus 100 may include a user interface section 110, an image forming section 120, a storage section 130, an interface section 140, and a control section 150.

The user interface section 110 provides a user interface related to an image forming operation and can set an image forming option and an option name according to a user's input. In this case, the user interface may include a region to select an image forming option such as a scan type option, a print type option, and/or a print order option and a region to endow an option name (e.g., option identifier) capable of being specified with respect to the image forming option. Further, the user interface section 110 can provide a user interface to search for the image forming option and/or the image data that have been matched to a predetermined option name.

The image forming section 120 may perform an image forming operation such as scanning and printing, and may include a scanning section 121, a printing section 122 or the like. In this case, the scanning section 121 may scan a document according to an image forming option set by the user interface section 110 and perform an image forming operation forming image data. Further, the printing section 122 may perform an image forming operation to print the image data on a paper. On the other hand, the image forming section 120 may include one of the scanning section 121 and the printing section 122 to perform only one of the image forming operation of the scanning operation and the printing operation.

The storage section 130 can match the image forming option set through the user interface section 110 and the image data formed through the image forming section 120 to an option name and store the set image forming option and the formed image data (e.g., correlated or matched to the option name). For example, in the case in which the image forming option is set to ‘single surface scanning’, ‘double surface printing’, or ‘printing in a scanned order’ and the option name is set to ‘A1’, one image forming option is matched to the option name ‘A1’. Further, the image data, which have been scanned and formed according to the image forming option matched to the option name ‘A1’, may be also matched to the option name ‘A1’.

The interface section 140 performs transmission and reception of data to and from an external network. In this case, the interface section 140 may be connected to another image forming apparatus (e.g., to a plurality of image forming apparatus) through the external network.

If a request signal including a target option name is received from at least one other requesting image forming apparatus (e.g., by the first image forming apparatus 100 from the second image forming apparatus 200) through an interface section 140, at least one of the image forming option and the image data, which have been matched to the same option name as the target option name, are transmitted to the requesting image forming apparatus. In one case, if the request signal including the target option name is a request signal on the image forming option, the control section 150 may transmit the image forming option, which has been matched to the same option name as the target option name, to the requesting image forming apparatus. For example, if a request signal including a target option name ‘A1’ is received from the requesting (e.g., an other) image forming apparatus, the control section 150 may transmit one image forming option that has been matched to the target option name ‘A1’, such as ‘single surface scanning’, ‘double surface printing’, ‘printing in the scanned order’, or the like to the other image forming apparatus. Further, if the request signal including the target option name is a request signal on the image data, the control section 150 may transmit the image data, which have been matched to the same option name as the target option name, to the other image forming apparatus.

On the other hand, if a search option name is input through the user interface section 110, a request signal including the search option name is output to a network through the interface section 140, and is transmitted to at least one other image forming apparatus (e.g., receiving image forming apparatus). Accordingly, at least one of the image forming option and the image data, which have been matched to the same option name as the search option name, may be received from the other image forming apparatus (e.g., receiving image forming apparatus). In this case, the control section 150 transmits the request signal including the search option name to the other image forming apparatus and/or may read at least one of the image forming option and the image data, which have been matched to the same option name as the search option name, from the storage section 130. In this way, at least one of the image forming option and the image data, which have been matched to the search option name ‘A1’ can be searched for through the image forming apparatus 100 and the other image forming apparatus. For example, when the image forming option that has been matched to the search option name ‘A1 is searched for, the control section 150 controls the scanning section 121 to scan a document according to the searched image forming option. Further, when the image data which have been matched to the search option name ‘A1’ is searched for, the control section 150 controls the printing section 122 to print the searched image data. In this case, the control section 150 controls the printing section 122 to print the image data according to the image forming option, which has been matched to the option name ‘A1, e.g, ‘double surface printing’ or ‘printing in a scanned order’. Accordingly, a user can scan a document according to an image forming option using only an option name to produce the printing data or can perform an image forming operation in the image forming apparatus 100 by searching for image data.

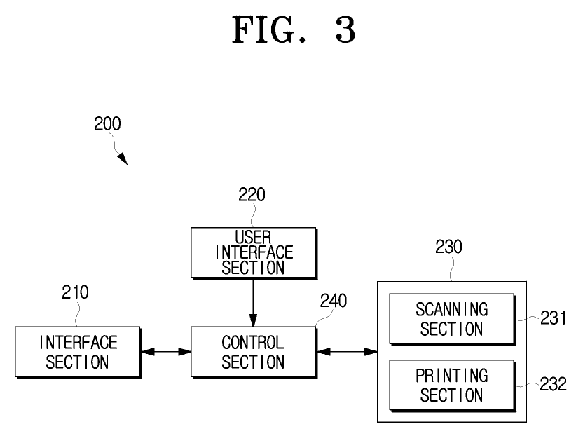

FIG. 3 is a block diagram illustrating an image forming apparatus according to another exemplary embodiment of the present general inventive concept. As illustrated in FIG. 3, the image forming apparatus 200 may include an interface section 210, a user interface section 220, an image forming section 230, and a control section 240.

The interface section 210 performs transmission and reception of data to and from an external network. For example, the interface section 210 can perform transmission and reception of data with another image forming apparatus or a plurality of image forming apparatus through a network.

The user interface section 220 can provide a user interface to input a search option name. In this case, if a user is to search for the image forming option and the image data, which have been matched to a predetermined option name, he or she can input a search option name. On the other hand, the user interface to input the search option name may include an input region through which a user can directly input a search option name, and may include a selection region through which a user can select an option name from a list.

The image forming section 230 can perform an image forming operation such as a scanning and a printing, and includes a scanning section 231 to scan a document to form image data and a printing section 232 to print the image data. In this case, the image forming section 230 may include one of the scanning section 231 and the printing section 232 to respectively perform one of the image forming operations of the scanning operation and the printing operation.

The control section 240 can transmit a request signal including a search option name to the external network through the interface section 210, and receive at least one of the image forming option and the image data, which have been matched (e.g., correspond) to the same option name as the search option name. For example, if the image forming option, which has been matched to the search option name, is received, the control section 240 can control the scanning section 231 to scan a document according to the received image forming option. Further, if the image data corresponding to the search option name is received, the control section 240 can control the printing section 232 to print the received image data. Accordingly, at least one of the image forming option and the image data, which have been matched to the option name, may be received (e.g., using a network) from another image forming apparatus using the option name in order to perform an image forming operation.

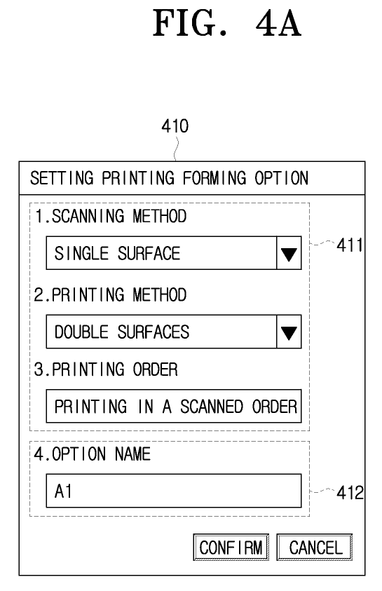

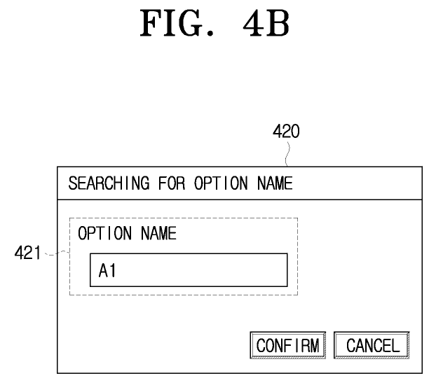

FIGS. 4A and 4B are diagrams illustrating a user interface according to various exemplary embodiments of the present general inventive concept. FIG. 4A is a diagram illustrating a first user interface to set an image forming option and an option name. As illustrated in FIG. 4A, the first user interface 410 may include an item 411 through which an image forming option, such as a scan type option, a print type option, and a print order option, can be input. However, the present general inventive concept is not intended to limit the item 411 to such exemplary entries of FIG. 4A since others may added or used to replace listed option characteristics. An item 412 may be used to input an option name.

For example, if ‘A1’ is input as an option name in the state in which ‘single surface scanning’ is input as the scanning method, ‘double surface printing’, as the printing method, and ‘printing in a scanned order’, as the printing order, ‘single surface scanning’, ‘double surface printing’, and ‘printing in a scanned order’ may be matched to the option name ‘A1’ as one exemplary image forming option.

In the case in which a document is scanned by the image forming option, which has been matched to the option name ‘A1’, the image forming apparatus 100 may scan the document according to ‘single surface scanning’ and form image data. For example, the document scanned in the image forming option of the option name ‘A1, the first scanned image data is designated as the printing order ‘1’, and the scanned image data is designated as the printing orders of ‘2, 3, 4, . . . ’. In this case, the image forming apparatus 100 matches the image data formed according to the image forming option, which has been matched to the option name ‘A1’, to the option name ‘A1’, and stores the image data.

On the other hand, if a user is to scan a document using an image forming option such as single surface scanning, double surface printing, or printing in a scanned order, he or she can directly or automatically set the single surface scanning, the double surface printing, or the printing in a scanned order through only inputting the option name ‘A1’ (e.g., without individually inputting the three methods included in the image forming option). Therefore, if a user is to scan a document using another image forming apparatus, a frequently used image forming option can be automatically set only by matching the image forming option to an option name and by inputting the option name, without newly setting a scanning method or a printing method.

FIG. 4B is a diagram illustrating a second user interface to input a search option name. As illustrated in FIG. 4B, the second user interface 420 may include an item 421 to input a search option name. If a user inputs ‘A1’ as a search option name, the image forming apparatus 200 may transmit a request signal including ‘A1’ to the other image forming apparatus connected to the image forming apparatus 200 through a network and receive the image data, which has been matched to the search option ‘A1’, from the other image forming apparatus. In this case, the image forming apparatus 200 can print image data according to the printing method and the printing order of the image forming option, which has been matched to the option name ‘A1’. Accordingly, a user can search for the image data only with the option name set before scanning a document and does not have to set the printing method and the printing order. Therefore, a printing operation can be directly, quickly and/or conveniently performed.

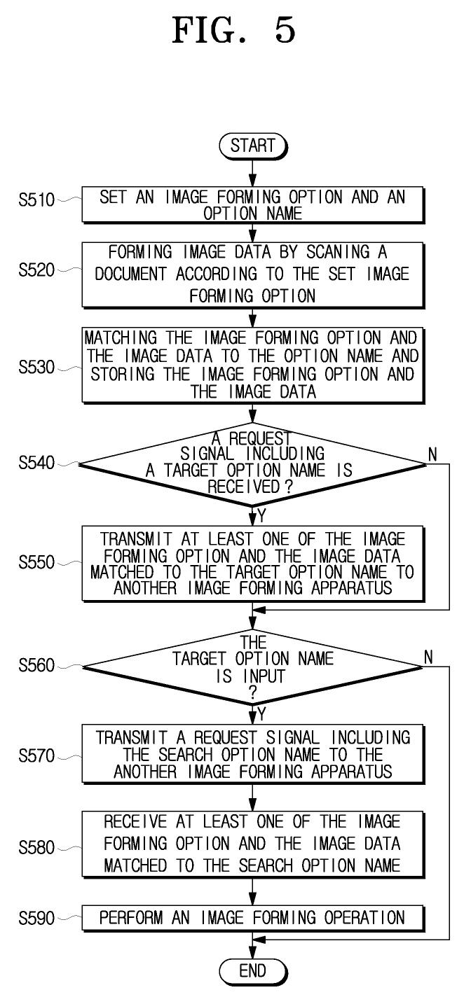

FIG. 5 is a flow chart explaining an image forming method of an image forming apparatus according to an exemplary embodiment of the present general inventive concept. As illustrated in FIG. 5, an image forming option and an option name may be set in the image forming apparatus 100 before a document is scanned (operation block S510). In this case, the image forming option may be provided to scan a document and/or to print image data, and may include a scanning method, a printing method, a printing order, or the like.

Next, the image forming apparatus 100 may form image data by scanning a document according to the set image forming option (operation block S520). The image forming apparatus 100 forms image data by scanning a document loaded according to the scanning method of the image forming option. For example, if the scanning method is set to ‘single surface scanning’, the image forming apparatus 100 forms image data by scanning a single surface of the document.

Thereafter, the image forming apparatus 100 may match the set image forming option and the formed image data to the option name and store the set image option and the formed image data (operation block S530). For example, if the option name set together with the image forming option at operation block S510 is ‘A1’, the corresponding image forming option and the image data formed at operation block S520 can be matched to the option name ‘A1’.

On the other hand, if a request signal including a target option name is received from at least one other image forming apparatus connected to the image forming apparatus through a network (operation block S540), the image forming apparatus 100 may transmit at least one of the image forming option and the image data, which correspond to the target option name, to the other image forming apparatus (operation block S550).

If a search option name is input (operation block S560), the image forming apparatus 100 may transmit a request signal including a search option name to at least one other image forming apparatus (operation block S570). In this case, the image forming apparatus 100 may transmit the request signal including the search option name to the other image forming apparatus and search for the image forming option and the image data, which have been matched to the search option name stored by itself, at the same time.

The image forming apparatus 100 may receive at least one of the image forming option and the image data, which have been matched to the same option name as the search option name, e.g., from the other image forming apparatus, (operation block S580).

Next, the image forming apparatus 100 may perform an image forming operation according to the received image forming option and/or the image data (operation block S590).

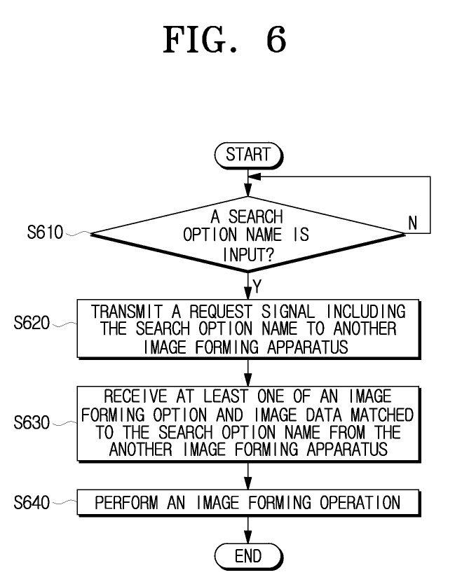

FIG. 6 is a flow chart explaining an image forming method of an image forming apparatus according to another exemplary embodiment of the present general inventive concept. As illustrated in FIG. 6, if a search option name is input (operation block S610), the image forming apparatus 200 can transmit a request signal including the search option name to another image forming apparatus (operation block S620).

Next, if at least one of the image forming option and the image data, which have been matched to the search option name for the another image forming apparatus according to the request signal is received (operation block S630), the image forming apparatus 200 may perform an image forming operation (operation block S640). For example, in the case in which a document is to be scanned, the image data is formed by scanning the document according to the received image forming option. Further, in the case in which the image data is to be printed, the received printing data is printed according to the printing method and the printing order of the image forming option, which has been matched to the search option name. Accordingly, if a user is to scan a document or to print image data using the image forming apparatus 200, the image forming option and the image data, which have been matched to the option name stored in the another image forming apparatus, can be searched for. Accordingly, an image forming operation can be easily performed.

Embodiments of an image forming methods were described with reference to and may be used in whole or in part by embodiments of an image forming system or apparatus in accordance with the present general inventive concept. The apparatus and method embodiments are not intended to be limited thereby.

Any reference in this specification to “one embodiment,” “an embodiment,” “example embodiment,” etc., means that a particular feature, structure, or characteristic described in connection with the embodiment is included in at least one embodiment of the invention. The appearances of such phrases in various places in the specification are not necessarily all referring to the same embodiment. Further, when a particular feature, structure, or characteristic is described in connection with any embodiment, it is submitted that it is within the purview of one skilled in the art to affect such feature, structure, or characteristic in connection with other ones of the embodiments. Furthermore, for ease of understanding, certain method procedures may have been delineated as separate procedures; however, these separately delineated procedures should not be construed as necessarily order dependent in their performance. That is, some procedures may be able to be performed in an alternative ordering, simultaneously, etc.

As described herein, according to the exemplary embodiments of the present general inventive concept, an image forming option corresponding to an option name can be set only with the option name to scan a document or to print image data, by setting the image forming option and the option name before scanning a document.

Further according to embodiments of the present general inventive concept, an image forming option can be set during a printing operation only by selecting an option name, which may improve the convenience for a user without separately setting an image forming option. Further, in the case in which image data are searched for using an option name, the image data having a same option name can be received from an image forming apparatus connected to a network to perform a printing operation.

Although a few embodiments of the present general inventive concept have been shown and described, it will be appreciated by those skilled in the art that changes may be made in these embodiments without departing from the principles and spirit of the general inventive concept, the scope of which is defined in the appended claims and their equivalents As used in this disclosure, the term “preferably” is non-exclusive and means “preferably, but not limited to.” Terms in the claims should be given their broadest interpretation consistent with the general inventive concept as set forth in this description. For example, the terms “coupled” and “connect” (and derivations thereof) are used to connote both direct and indirect connections/couplings. As another example, “having” and “including”, derivatives thereof and similar transitional terms or phrases are used synonymously with “comprising” (i.e., all are considered “open ended” terms)—only the phrases “consisting of” and “consisting essentially of” should be considered as “close ended”. Claims are not intended to be interpreted under 112 sixth paragraph unless the phrase “means for” and an associated function appear in a claim and the claim fails to recite sufficient structure to perform such function.

What is claimed is:

1. An image forming apparatus comprising:
an image forming section to form image data according to a set image forming option;
a user interface to endow an option name capable of being specified with respect to the set image forming option;
a storage section to match the set image forming option and the formed image data to the option name and to store the set image forming option and the formed image data; and
a control section to transmit at least one of the image forming option and the image data matched to a same option name as a target option name to another image forming apparatus, if a request signal including the target option name is received from said another image forming apparatus.

2. The image forming apparatus of claim 1, wherein if the request signal including the target option name is a request signal on the image forming option, the control section transmits the image forming option matched to the same option name as the target option name to the another image forming apparatus.

3. The image forming apparatus of claim 1, wherein if the request signal including the target option name is a request signal on the image data, the control section transmits the image data matched to the same option name as the target option name to the another image forming apparatus.

4. The image forming apparatus of claim 1, further comprising:
an interface section to perform transmission and reception of data to and from an external network,
wherein if a search option name is input through the user interface section, the control section receives at least one of the image forming option and the image data matched to a same option name as the search option name from a different image forming apparatus by transmitting a request signal including the search option name to the external network through the interface section.

5. The image forming apparatus of claim 4, wherein if the image forming option matched to the same option name as the search option name is received, the control section controls the image forming section to scan a document according to the received image forming option and to form the image data.

6. The image forming apparatus of claim 4, wherein if the image data matched to the same option name as the search option name is received, the control section controls the image forming section to print the received image data on a paper.

7. The image forming apparatus of claim 1, wherein the image forming option is one of a scan type option, a print type option, and a print order option.

8. An image forming apparatus comprising:
an interface section to perform transmission and reception of data to and from an external network;
a user interface section to input a search option name; and
a control section to receive at least one of an image forming option or image data matched to the search option name by transmitting a request signal including the search option name to the external network through the interface section.

9. The image forming apparatus of claim 8, further comprising:
an image forming section to perform an image forming operation,
wherein when the image forming option matched to the search option name is received, the control section controls the image forming section to perform an image forming operation for scanning a document according to the received image forming option.

10. The image forming apparatus of claim 8, further comprising:
an image forming section to perform an image forming operation,
wherein when the image data matched to the search option name is received, the control section controls the image forming section to perform an image forming operation for printing the received image data.

11. The image forming apparatus of claim 8, wherein the image forming option is at least one of a scan type option, a print type option, or a print order option.

12. An image forming method of a first image forming apparatus connected to a second image forming apparatus through an interface comprising:
endowing a first option name capable of being specified with respect to a set image forming option;
forming image data by scanning a document according to the set image forming option;
matching the set image forming option and the formed image data to the first option name and storing the set image forming option and the formed image data; and
transmitting at least one of the image forming option or the image data matched to the first option name to the second image forming apparatus when a request signal including a target option name matched to the first option name is received from the second image forming apparatus.

13. The image forming method of claim 12, wherein in said transmitting, when the request signal including the target option name received from the second image forming apparatus is a request signal on the image forming option, the image forming option for the first option name matched to the target option name is transmitted to the second image forming apparatus.

14. The image forming method of claim 12, wherein in said transmitting, when the request signal including the target option name received from the second image forming apparatus is a request signal on the image data, the image forming data for the first option name matched to the target option name is transmitted to the second image forming apparatus.

15. The image forming method of claim 12, further comprising:
inputting a search option name through a user interface; and
receiving at least one of the image forming option or the image data for an option name matched to the search option name from the second image forming apparatus by transmitting a request signal including the search option name through the interface section.

16. The image forming method of claim 15, further comprising:
forming the image data by scanning a document according to the received image forming option when the image forming option for the option name matched to the search option name is received from the second image forming apparatus.

17. The image forming method of claim 15, further comprising:
forming the image data by printing the received image data on a paper when the image data for the option name matched to the search option name are received from the another image forming apparatus.

18. The image forming method of claim 12, wherein the image forming option is at least one of a scan type option, a print type option, and a print order option.

19. An image forming apparatus comprising:
an image forming unit to form image data according to a selected image forming option;
a user interface to specify an option name and a corresponding image forming option to include at least one characteristic of image forming;
a storage section to store the corresponding image forming option and formed image data matched to the option name; and
a control section to receive a request signal with a target option name from a networked image forming apparatus, the control section to determine whether stored option names match the received target option name.

20. The image forming apparatus of claim 19, wherein the control section is configured to transmit to the networked image forming apparatus at least one of the corresponding image forming option or the corresponding image data for the option name matched to the received target option name.

21. The image forming apparatus of claim 20, wherein when the request signal with the target option name is a request signal for the image forming option, the control section to transmit the corresponding image forming option of the matched option name to the networked image forming apparatus.

22. The image forming apparatus of claim 20, wherein when the request signal with the target option name is a request signal for the image data, the control section to transmit the corresponding image data of the matched option name to the networked image forming apparatus.

23. The image forming apparatus of claim 19, further comprising:
an interface section to perform transmission and reception of data to and from an external network or another image forming apparatus,
wherein the user interface section is configured to input a search option name,
wherein the interface section is configured transmit a request signal with the search option name,
and wherein the control section is configured to receive at least one of an image forming option and an image data corresponding to the search option name from the external network or said another image forming apparatus.

24. The image forming apparatus of claim 23, wherein when the image forming option matched to the search option name is received, the control section is configured to control the image forming section to scan an input document according to the received image forming option to form input document image data.

25. The image forming apparatus of claim 23, wherein when the image data matched to the search option name is received, the control section is configured to control the image forming section to print the received image data.

26. The image forming apparatus of claim 19, wherein the image forming option is at least one of a scan type option, a print type option, and a print order option.

27. An image forming apparatus comprising:
an interface section to perform transmission and reception of data to and from an external network;
a user interface section to input a search option name; and
a control section to receive at least one of an image forming option or image data matched to the search option name by transmitting a request signal including the search option name to the external network through the interface section.

28. The image forming apparatus of claim 27, further comprising:
an image forming section to perform an image forming operation,
wherein when the image forming option matched to the search option name is received, the control section to control the image forming section to perform an image forming operation to scan a document according to the received image forming option.

29. The image forming apparatus of claim 27, further comprising:
an image forming section to perform an image forming operation,
wherein when the image data matched to the search option name is received, the control section to control the image forming section to perform an image forming operation to print the received image data.

30. The image forming apparatus of claim 27, further comprising:
an image forming unit to form image data according to a selected image forming option;
the user interface is configured to specify an option name to correspond to an image forming option configured to include at least one characteristic of image forming;
a storage section to store the specified image forming option and formed image data matched to the option name; and
the control section is configured to receive a request signal with a target option name from another image forming apparatus, the control section to determine whether stored option names match the received target option name and transmit to said another image forming apparatus at least one of the corresponding image forming option or the corresponding image data for the option name matched to the received target option name, wherein the image forming option is at least one of a scan type option, a print type option, or a print order option.

31. An image forming method comprising:
providing an option identifier for a corresponding image forming option configured to have at least one image forming parameter;
forming image data by scanning according to a selected image forming option;
storing one or more of a corresponding image forming option or a corresponding image data matched to each option identifier; and
transmitting at least one of the image forming option or the image data matched to a first option identifier from a first image forming apparatus to a second image forming apparatus when a request signal including a target option name corresponding to the first option identifier is received from the second image forming apparatus.

32. The image forming method of claim 31, wherein when the request signal including the target option name is a request signal for the image forming option, the image forming option for the first option identifier equal to the target option name is transmitted to the second image forming apparatus.

33. The image forming method of claim 31, wherein when the request signal including the target option name is a request image data signal, the image forming data for the first option identifier equal to the target option name is transmitted to the second image forming apparatus.

34. The image forming method of claim 31, further comprising:
inputting a search option name through a user interface at the first image forming apparatus; and
receiving at least one of the corresponding image forming option or the corresponding image data for an option identifier matched to the search option name from the second image forming apparatus by transmitting a request signal including the search option name through an interface.

35. The image forming method of claim 34, further comprising:
forming the image data by scanning a document according to the received image forming option when the image forming option for the option identifier matched to the search option name is received from the second image forming apparatus.

36. The image forming method of claim 34, further comprising:
forming the image data by printing the received image data on a paper when the image data for the option identifier matched to the search option name is received from the second image forming apparatus.

37. The image forming method of claim 32, wherein the image forming option is at least one of a scan type option, a print type option, and a print order option.
